(19) United States
(12) Patent Application Publication
(10) Pub. No.: US 2010/0287992 A1
(43) Pub. Date: Nov. 18, 2010

(54) FOREHEARTH

(75) Inventor: Mark Hayton, Western Australia (AU)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TECHNOLOGICAL RESOURCES PTY. LIMITED, Milbourne (AU)

(21) Appl. No.: 12/293,740

(22) PCT Filed: Mar. 22, 2007
(86) PCT No.: PCT/AU2007/000355

§ 371 Date: Aug. 3, 2010

(30) Foreign Application Priority Data
Mar. 22, 2006 (AU) 2006901473

(51) Int. Cl. C03B 5/26

(52) U.S. Cl. 65/324

(57) ABSTRACT

A forehearth (5) for containing a volume of molten material and a direct smelting vessel (3) that includes the forehearth are disclosed. The forehearth includes a forehearth connection (15) for connecting the foreheath with a smelting chamber (4) of a smelting vessel (8) so that molten material can flow from the smelting chamber into the forehearth. The forehearth connection is formed so that there is an unrestricted line of sight through the forehearth connection from a location that is external to the forehearth. This makes it possible to unblock the forehearth connection by a mechanical drill or other equipment extending into the forehearth connection and operated externally of the forehearth.

The present invention relates to continuous production of molten material.

The present invention relates particularly, although by no means exclusively, to continuous production of molten iron from metalliferous feed material via a molten bath-based direct smelting process carried out in a vessel that includes a forehearth that allows flow of molten iron continuously from the vessel.

The present invention also relates to a direct smelting vessel that includes a forehearth.

Whilst continuous production of molten iron from a direct smelting vessel via a forehearth has a number of advantages over batch production of molten iron from the vessel, there are safety risks associated with providing what amounts to an open connection between the interior of the direct smelting vessel and the exterior of the vessel. In particular, there is a risk of pressure perturbations in the vessel causing unexpected surges of molten iron from the vessel. As a consequence, from a safety viewpoint, there is a preference for a forehearth connection that has a relatively small-diameter.

One adverse consequence of the use of a relatively small-diameter forehearth connection is that there is an increased risk of metal freezing in the connection and, as a result, an increased risk of the connection becoming blocked during operation of a direct smelting process in a direct smelting vessel. The risk of blockage tends to be higher during a start-up phase of the process than during a steady state production phase of the process. Nevertheless, blockage of the forehearth connection during any phase of the process is undesirable.

Unblocking a relatively small-diameter forehearth connection is potentially very dangerous for personnel carrying out the operation when a vessel contains molten iron. Unblocking a forehearth connection under these circumstances can only be carried out by operators positioned externally of the forehearth. When operator access to the forehearth is necessary to unblock a forehearth connection, for safety reasons this can only be permitted when the vessel has been tapped. A blockage of a forehearth connection in these circumstances requires a vessel shutdown and consequential lost production and is undesirable on this basis.

One aspect of the present invention provides a forehearth structure that makes it possible for operators to gain access to a forehearth connection externally of the forehearth.

Another aspect of the present invention provides a forehearth structure that minimises the amount of molten iron in the region of a forehearth connection in an end tap situation.

According to a first aspect of the present invention there is provided a forehearth for a direct smelting vessel having a hearth region for containing molten material, the forehearth being adapted to contain a volume of the molten material, the forehearth including an outlet in an upper section thereof for flow of molten material from the forehearth, a forehearth connection in a lower section of the forehearth for flow of molten material into the forehearth from the hearth region of the vessel, the forehearth connection including a passageway having a passageway entrance for molten material to flow into the passageway from the hearth region and a passageway exit for flow of molten material from the passageway into the forehearth, and wherein when the forehearth is empty there is an unrestricted line of sight through the forehearth connection to the passage entrance from a location that is external to and above the level of the upper section of the forehearth.

The above-described unrestricted line of sight through the forehearth connection from the location that is external to and above the level of the upper section of the forehearth to the passageway entrance makes it possible to attempt to unblock a blocked forehearth connection by means of an oxygen lance or a mechanical drill or other suitable unblocking means that extends into the passageway and is operated externally of the forehearth. This is an important feature from a safety viewpoint.

Preferably the passageway of the forehearth connection includes an upper wall that is inclined upwardly as viewed looking from the passageway entrance towards the passageway exit.

Preferably the angle of inclination of the upper wall is selected having regard to other parts of the forehearth so that the passageway of the forehearth connection can be accessed by an oxygen lance, mechanical drill, etc from externally of the forehearth.

Preferably a line extending along the upper wall of the forehearth connection intersects a point on a wall of the forehearth that is located opposite the forehearth connection and access to the forehearth connection from a point external to the forehearth is provided adjacent the point of intersection. More preferably the point of intersection provides the outlet for the molten metal.

Preferably the upper wall of the forehearth connection is at an angle of 20-40° to the horizontal.

More preferably the upper wall of the forehearth connection is at an angle of 25-35° to the horizontal.

Preferably the passageway of the forehearth connection is a constant transverse cross-section along the length thereof.

Preferably the forehearth is L-shaped in side elevation, with a horizontal arm section and a vertical arm section extending upwardly from one end of the horizontal arm section.

With such an arrangement, preferably the forehearth connection is located in the horizontal arm section of the “L”.

In addition, preferably the forehearth includes a main chamber for molten material in the upstanding arm section of the “L” and an inlet chamber for molten material in the horizontal arm section of the “L” that interconnects the forehearth connection and the main chamber.

Preferably the inlet chamber includes an upper wall that is inclined upwardly as viewed looking outwardly from the forehearth connection.

Preferably the upper wall of the inlet chamber is a straight line extension of the inclined upper wall of the passageway of the forehearth connection.

Preferably the inlet chamber includes side walls that taper from a relatively wide opening in communication with the main chamber to a relatively narrow opening in communication with the passageway of the forehearth connection.

Preferably the main chamber, the inlet chamber, and the forehearth connection are lined with refractory material.

Preferably the forehearth outlet is in the form of a spout that extends outwardly and upwardly from the forehearth.

Preferably the spout is located so that it is aligned with the passageway of the forehearth connection so that the line of sight extends through the spout and through the forehearth connection to the passageway entrance.

Preferably the line of sight extends adjacent to and above an upper surface of the spout.

Preferably the spout is in an upper section of an end wall of the forehearth and is spaced below a top surface of the forehearth. With this arrangement, the section of the forehearth that extends above the spout provides an additional volume in the main chamber that makes it possible to accommodate an unexpected surge of molten material within the forehearth with molten material still able to flow in a controlled way from the forehearth via the spout and without uncontrolled overflow from other sections of the forehearth.

Preferably the forehearth includes an overflow drain assembly for controlled flow of molten material from the forehearth in emergency situations in which there are higher flow rates of molten material into the forehearth than can be handled by the forehearth outlet.

Preferably the foreheath further includes an end tap drain in a lower section of the forehearth for flow of molten material from the forehearth, the end tap drain being selectively openable in situations in which it is necessary to end tap the vessel, and the forehearth including a bottom wall that slopes downwardly away from the forehearth connection to the end tap drain to facilitate flow of molten material away from the forehearth connection to the end tap drain in an end tap situation.

Preferably a lower surface of the inlet chamber slopes downwardly from the bottom wall of the forehearth.

Preferably the lower surface of the inlet chamber and the bottom wall are co-planar.

According to a second aspect of the present invention there is also provided a forehearth for a direct smelting vessel having a hearth region for containing molten material, the forehearth being adapted to contain a volume of the molten material, the forehearth including an outlet in an upper section thereof for flow of molten material from the forehearth, a forehearth connection in a lower section of the forehearth for flow of molten material into the forehearth from the hearth region of the vessel, an end tap drain in a lower section of the forehearth for flow of molten metal from the forehearth, the end tap drain being selectively openable in situations in which it is necessary to end tap the vessel, and the forehearth including a bottom wall that slopes downwardly away from the forehearth connection to the end tap drain to facilitate flow of molten material away from the forehearth connection to the end tap drain in an end tap situation.

The above-described sloping bottom wall of the body of the forehearth minimises the amount of molten material around the forehearth connection. This is important in terms of minimising the amount of material that solidifies in the region of the forehearth connection after end tapping the vessel.

According to a third aspect of the present invention there is provided a direct smelting vessel for producing molten material from a metalliferous feed material via a molten bath-based direct smelting process carried out in the vessel, the vessel including a fixed, upright smelting vessel that includes a smelting chamber and a forehearth for allowing flow of molten material from the smelting chamber that extends outwardly from the smelting vessel and includes the features of one or both of the above-described first and second aspects of the present invention.

Preferably the smelting vessel includes a generally cylindrical barrel section that includes a refractory-lined hearth region and a generally cylindrical offgas chamber that define the said smelting chamber, and the smelting chamber of the smelting vessel is adapted to contain a molten bath and a gas space above the molten bath.

Preferably the vessel further includes (a) a means for supplying solid feed materials into the smelting chamber, (b) a means for supplying an oxygen-containing gas into the smelting chamber, (c) an offgas duct for allowing offgas produced in the process to flow from the smelting chamber, (d) a means for allowing molten slag to flow from the smelting chamber, and (e) the above-described forehearth for allowing flow of molten material from the smelting chamber into and thereafter from the forehearth that includes the features of one or both of the above-described first and second aspects of the present invention.

Preferably the forehearth is positioned so that the forehearth connection communicates with a lower section of the hearth region.

Preferably the forehearth connection is housed in the refractory-lining of the hearth region.

The present invention is described further by way of example with reference to the accompanying drawings, of which:

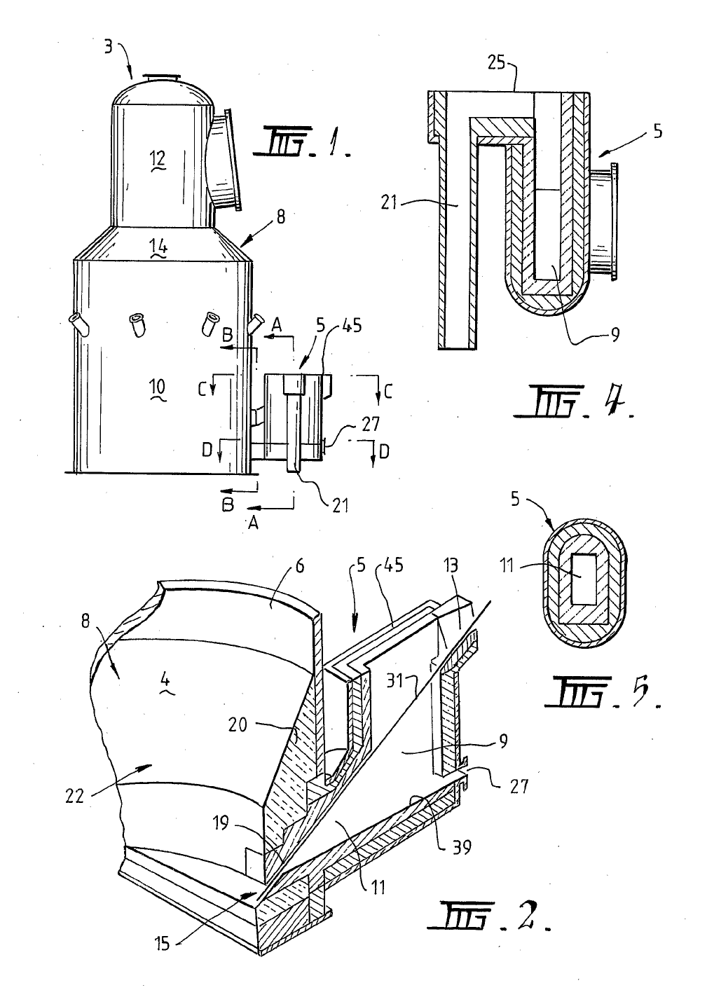

FIG. 1 is a side elevation of one embodiment of a forehearth and one embodiment of a direct smelting vessel that includes the forehearth in accordance with the present invention;

FIG. 2 is a cut-away perspective view of a part of the vessel shown in FIG. 1 that shows the interior of the vessel and the interior of the forehearth for allowing molten material to flow from the vessel;

FIG. 3 is a side elevation of the part of the vessel shown in FIG. 2;

FIG. 4 is a cross-section along the line A-A of FIG. 1;

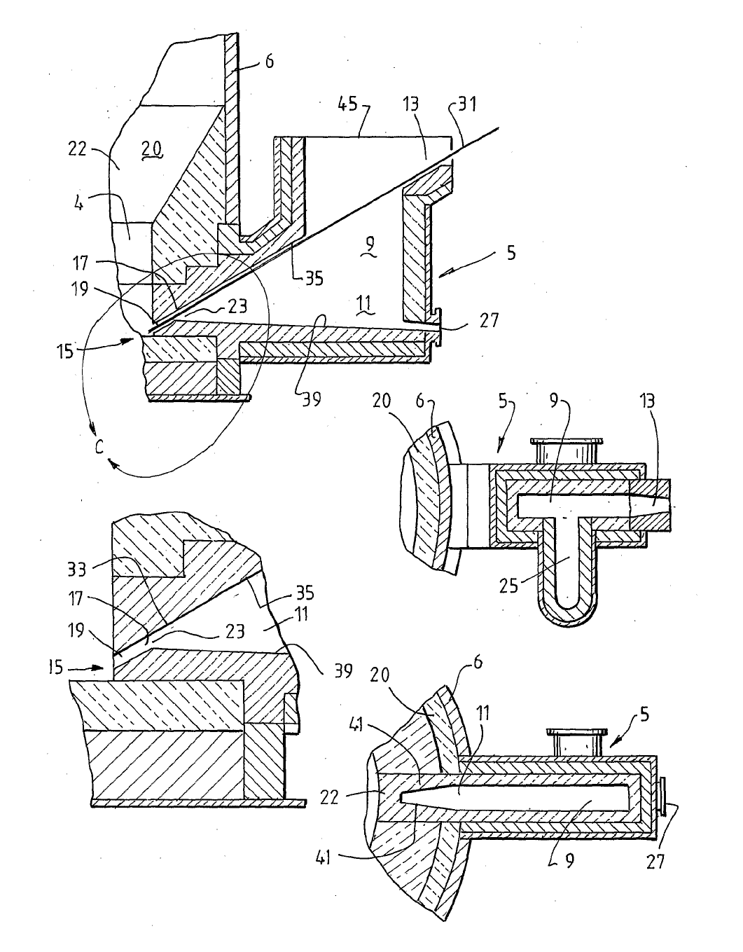

FIG. 5 is a cross-section along the line B-B of FIG. 1;

FIG. 6 is a cross-section along the line C-C of FIG. 1;

FIG. 7 is a cross-section along the line D-D of FIG. 1; and

FIG. 8 is an enlargement of the circled region C in FIG. 3.

The embodiment of the forehearth and the embodiment of the direct smelting vessel that includes the forehearth in accordance with the present invention shown in the Figures are described in the context of producing molten iron from a metalliferous feed material, such as iron ore fines, in a molten bath-based direct smelting process. Such processes may operate at pressure and be performed in enclosed pressure vessels. For example the process known as the HIsmelt direct smelting process that has been developed by the applicant, operates at a typical pressure of 0.8 bar gauge (1.8 bar atmosphere).

It is noted that the present invention is not confined to producing molten iron.

It is also noted that the forehearth is not confined to use in the production of molten iron and may be used as part of metallurgical vessels producing other metals and alloys.

The vessel is generally identified by the numeral 3.

The vessel 3 includes (a) a fixed, upright smelting vessel generally identified by the numeral 8 for producing molten iron and (b) the above-mentioned forehearth generally identified by the numeral 5 for discharging molten iron from the smelting vessel 8 extending outwardly from the smelting vessel 8.

The vessel 3 may be any direct smelting vessel. The vessel 3 is of a general type shown in published International applications in the name of the applicant and the disclosure in these International applications is incorporated by cross-reference.

The smelting vessel 8 defines a smelting chamber 4 and includes a generally cylindrical barrel section 10, a generally cylindrical offgas chamber 12, and a frusto-conical roof 14 that interconnects the barrel section 10 and the offgas chamber 12.

The smelting vessel 8 includes an outer steel shell 6 and an inner refractory lining 20, particularly in a hearth region 22 of the vessel 8.

The forehearth 5 allows molten iron produced in a molten bath-based direct smelting process carried out in the smelting chamber 4 of the smelting vessel 8 to be discharged continuously from the vessel 8 via the forehearth 5.

The forehearth 5 is a refractory-lined structure that is generally L-shaped, with a horizontal arm section that extends outwardly from the barrel section 10 of the smelting vessel 8 and a vertical arm section that extends upwardly from the horizontal arm section. A central vertical plane of the foreheath 5 is on a radial of the barrel section 10.

The forehearth 5 includes a main chamber 9 for molten iron in the vertical arm section and an inlet chamber 11 for molten iron in the horizontal arm section.

The forehearth 5 also includes:
(a) an outlet 13 in the form of a spout in an upper section of the forehearth for allowing molten iron to discharge from the forehearth 5; and
(b) a forehearth connection, generally identified by the numeral 15, in a lower section of the forehearth for allowing molten iron to flow from the smelting chamber 4 of the vessel 3 into the forehearth 5.

The main chamber 9 of the forehearth 5 has a substantially constant transverse cross-sectional area throughout the height of the chamber 9.

With reference to FIG. 7, the inlet chamber 11 of the forehearth 5 is at least partially housed in the refractory lining 20 of the hearth region 22 of the smelting vessel 8 and includes side walls 41 that converge towards each other from a relatively wide opening that communicates with the main chamber 9 to a relatively narrow opening that communicates with the forehearth connection 15.

The forehearth outlet 13 is spaced below a top surface 45 of an end wall of the forehearth 5 (see FIG. 3). With this arrangement, the section of the forehearth 5 that extends above the outlet 13 provides an additional volume in the main chamber 9 that makes it possible to accommodate an unexpected surge of molten material within the forehearth 5 with molten material still able to flow in a controlled way from the forehearth 5 via the outlet 13 and without (or with minimised) uncontrolled overflow from other sections of the forehearth 5.

The forehearth connection 15 is housed in the refractory lining 20 of the hearth region 22 of the smelting vessel 8.

The forehearth connection 15 includes a relatively narrow, straight passageway 17 that has a constant transverse cross-section.

The passageway 17 has a passageway entrance 19 that is located at an inner surface of the refractory lining 20 of the hearth region 22 of the smelting vessel 8 so that molten iron can flow into the passageway 17 from the hearth region 22 of smelting chamber 4 of the smelting vessel 8. The passageway 17 also includes a passageway exit 23 that opens into the inlet chamber 11 of the forehearth 5 so that molten iron can flow through the forehearth connection 15 into the inlet chamber 11. International application PCT/AU2006/000545 in the name of the applicant provides additional details on the sizing and configuration of forehearth connections.

A longitudinal axis of the passageway 17 is located on a radial of the barrel section 10 of the smelting vessel 8 and extends upwardly and outwardly from the smelting vessel 8 at an angle of 31° to the horizontal. As is discussed further hereinafter, this angle is selected having regard to other parts of the forehearth 5 so that the passageway 17 can be accessed by an oxygen lance, a mechanical drill, etc from externally of the forehearth 5.

Specifically, the arrangement of the passageway 17, the inlet chamber 11, the main chamber 9, and the forehearth outlet 13 is such that, when the forehearth 5 is empty, there is an unrestricted line of sight through the forehearth connection 15 to the passageway entrance 19 from a location that is external to and above the level of the upper section of the forehearth 5.

The unrestricted line of sight is indicated by the lines marked by the numeral 31 in FIGS. 2 and 3.

The unrestricted line of sight makes it makes it possible to attempt to unblock a blocked forehearth connection 15, and more particularly a blocked passageway 17, by means of an oxygen lance or a mechanical drill or other suitable unblocking means that extends into the forehearth connection 15 and is operated in a comparatively safe position externally to and above the level of the upper section of the forehearth 5.

In particular, the unrestricted line of sight makes it makes it possible to attempt to unblock a blocked forehearth connection 15, and more particularly a blocked lo passageway 17, when there is molten material, such as molten iron and molten slag, in the smelting chamber 4 in the vessel 3.

The unrestricted line of sight is the result of forming:
(a) the passageway 17, and in particular an upper wall 33 of the passageway 17 (see FIG. 8), so that it is upwardly inclined (a sufficient extent relative to other parts of the forehearth 5) when viewed from the smelting chamber 4 and looking outwardly through the passageway 17 to the inlet chamber 11;
(b) an upper wall 35 of the inlet chamber 11 (see FIG. 8) so that it does not extend below the upper wall 33 of the passageway 17 and, for example, is a straight line extension of the upper wall 33 and, therefore, is also inclined upwardly and outwardly as viewed from the smelting chamber 4; and
(c) the forehearth outlet 13 to be in the end wall of the forehearth 5 and at a height so that it is aligned with the passageway 17, whereby the line of sight extends through the outlet 13 and an oxygen lance or a mechanical drill or other suitable unblocking means can be located to extend into the passageway 17 and be operated externally of the forehearth 5.

According to an alternate embodiment a line extending along the upper wall 33 of the passageway 17 passes through the inlet chamber 11 and the main chamber 9 and intersects a point on wall of the forehearth that is located opposite the forehearth connection. Access to the forehearth connection from a point external to the forehearth is provided adjacent this point of intersection. The point of intersection adjacent where access to the forehearth is provided may additionally provide an outlet for molten metal to flow from the forehearth.

The forehearth 5 also includes an end tap drain 27 in a lower section of the forehearth 5.

The end tap drain 27 is closed during normal operating conditions but can be opened to allow molten iron to flow from the forehearth 5 when it is necessary to end tap the vessel 3.

With reference to FIGS. 2, 3, and 7, the end tap drain 27 is positioned in a side wall of the main chamber 9 in alignment with the passageway 17 of the forehearth connection 15.

A bottom wall 39 of the main chamber 9 and the inlet chamber 11 slope downwardly away from the exit 23 of the passageway 17 to the end tap drain 27 to facilitate flow of molten iron away from the passageway exit 23 to the end tap drain 27 in an end tap situation. Hence, this arrangement minimises the amount of molten iron in the region of the forehearth connection 15 in an end tap situation.

The forehearth 5 also includes an overflow assembly for allowing molten iron to flow from the forehearth 5 in emergency situations in which there are flow rates of molten iron that can not be handled by the outlet 13.

With reference to FIGS. 4, 6, and 7, the overflow assembly includes a discharge pipe 21 having an inlet 25 that communicates with an upper section of the forehearth 5.

The pipe inlet 25 of the discharge pipe 21 is at a height of the forehearth 5 that is higher than the forehearth outlet 13.

The above-described forehearth 5 is a particularly efficient construction for a direct smelting vessel 3 that is intended to operate for extended campaigns, typically at least 12 months, without a major shutdown.

Typically, the smelting chamber 4 and the forehearth 5 are constructed as separate components and are assembled together to form the vessel 3.

Many modifications may be made to the embodiments of the forehearth and the direct smelting vessel in accordance with the present invention shown in the Figures and described above without departing from the spirit and scope of the present invention.

1. A forehearth for a direct smelting vessel having a hearth region for containing molten material, the forehearth being adapted to contain a volume of the molten material, the forehearth including an outlet in an upper section thereof for flow of molten material from the forehearth, a forehearth connection in a lower section of the forehearth for flow of molten material into the forehearth from the hearth region of the vessel, the forehearth connection including a passageway having a passageway entrance for molten material to flow into the passageway from the hearth region and a passageway exit for flow of molten material from the passageway into the forehearth, and wherein when the forehearth is empty there is an unrestricted line of sight through the forehearth connection to the passageway entrance from a location that is external to and above the level of the upper section of the forehearth.

2. The forehearth defined in claim 1 wherein the passageway of the forehearth connection includes an upper wall that is inclined upwardly as viewed looking outwardly from the passageway entrance to the passageway exit.

3. The forehearth defined in claim 2 wherein the upper wall of the forehearth connection is at an angle of 20-40° to the horizontal.

4. The forehearth defined in claim 2 wherein the upper wall of the forehearth connection is at an angle of 25-35° to the horizontal.

5. The forehearth defined in claim 1 wherein the passageway of the forehearth connection is a constant transverse cross-section along the length thereof.

6. The forehearth defined in claim 1 wherein the forehearth is L-shaped in side elevation, with a horizontal arm section and a vertical arm section extending upwardly from one end of the horizontal arm section.

7. The forehearth defined in claim 6 wherein the forehearth connection is located in the horizontal arm section of the “L”.

8. The forehearth defined in claim 6 wherein the forehearth includes a main chamber for molten material in the upstanding arm section of the “L” and an inlet chamber for molten material in the horizontal arm section of the “L” that interconnects the forehearth connection and the main chamber.

9. The forehearth defined in claim 8 wherein the inlet chamber includes an upper wall that is inclined upwardly as viewed looking outwardly from the forehearth connection.

10. The forehearth defined in claim 9 wherein the upper wall of the inlet chamber is a straight line extension of the inclined upper wall of the passageway of the forehearth connection.

11. The forehearth defined in claim 8 wherein the inlet chamber includes side walls that taper from a relatively wide opening in communication with the main chamber to a relatively narrow opening in communication with the passageway of the forehearth connection.

12. The forehearth defined in claim 8 wherein the main chamber, the inlet chamber, and the forehearth connection are lined with refractory material.

13. The forehearth defined in claim 1 wherein the forehearth outlet is in the form of a spout that extends outwardly and upwardly from the forehearth.

14. The forehearth defined in claim 13 wherein the spout is located so that it is aligned with the passageway of the forehearth connection so that the line of sight extends through the spout and through the forehearth connection to the passageway entrance.

15. The forehearth defined in claim 13 wherein the line of sight extends adjacent to and above an upper surface of the spout.

16. The forehearth defined in claim 13 wherein the spout is in an upper section of the forehearth and is spaced below a top surface of the forehearth.

17. The forehearth defined in claim 1 wherein the forehearth includes an overflow drain assembly for controlled flow of molten material from the forehearth in emergency situations in which there are higher flow rates of molten material into the forehearth than can be handled by the forehearth outlet.

18. The forehearth defined in claim 1 wherein the forehearth further includes an end tap drain in a lower section of the forehearth for flow of molten material from the forehearth, the end tap drain being selectively openable in situations in which it is necessary to end tap the vessel, and the forehearth including a bottom wall that slopes downwardly away from the forehearth connection to the end tap drain to facilitate flow of molten material away from the forehearth connection to the end tap drain in an end tap situation.

19. A forehearth for a direct smelting vessel having a hearth region for containing molten material, the forehearth being adapted to contain a volume of the molten material, the forehearth including an outlet in an upper section thereof for flow of molten material from the forehearth, a forehearth connection in a lower section of the forehearth for flow of molten material into the forehearth from the hearth region of the vessel, an end tap drain in a lower section of the forehearth for flow of molten metal from the forehearth, the end tap drain being selectively openable in situations in which it is necessary to end tap the vessel, and the forehearth including a bottom wall that slopes downwardly away from the forehearth connection to the end tap drain to facilitate flow of molten material away from the forehearth connection to the end tap drain in an end tap situation.

20. A direct smelting vessel for producing molten material from a metalliferous feed material via a molten bath-based direct smelting process carried out in the vessel, the vessel including (a) a fixed, upright smelting vessel that includes a smelting chamber and (b) the forehearth for allowing flow of molten material from the smelting chamber defined in any one of the preceding claims that extends outwardly from the smelting vessel.
